(19) United States
(12) Patent Application Publication
(10) Pub. No.: US 2006/0057282 A1
(43) Pub. Date: Mar. 16, 2006

(54) Converter repair method

(76) Inventor: Madjid Soofi, St. Charles, IL (US)

Correspondence Address: BRINKS HOFER GILSON & LIONE, P.O. BOX 10395, CHICAGO, IL, 60610, US

(21) Appl. No.: 11/224,699

(22) Filed: Sep. 12, 2005

Related U.S. Application Data
(60) Provisional application No. 60/609,058, filed on Sep. 10, 2004.

(51) Int. Cl. B05D 3/00

(52) U.S. Cl. 427/140

(57) ABSTRACT

A method of repairing the lining of a converter includes disposing a refractory composition onto a worn surface of the converter. The refractory composition includes alumina, silicon carbide, and silica. The method may also include disposing a nozzle into a tuyere, pumping a refractory composition through the nozzle and onto a worn surface of the converter, and allowing the refractory composition to flow onto the worn surface of the refractory.

### RELATED APPLICATIONS

This application claims the benefit of U.S. Provisional Patent Application No. 60/609,058 , filed Sep. 10, 2004, the entire disclosure of which is hereby incorporated herein by reference

### BACKGROUND OF THE INVENTION

Vessels used to smelt or refine various metals, including copper, are lined with refractory linings capable of withstanding the temperatures and other wear forces such as thermal shock and mechanical erosion encountered in the smelting or refining process. The principal vessels used in such refining are known as convertors. These types of vessels incorporate pipes through the refractory lining which are used to inject air or other gases into the material being refined or smelted. Such pipes are commonly known as tuyeres. The number of tuyeres varies widely depending on the particular use. For example, a convertor may have 20 to 60 tuyeres depending on the size of the vessel and the output capacity of the vessel.

In the converter, the relatively cold gases are forced through the tuyeres into the material being refined or smelted and react with the material to generate substantial heat. In addition, the pressure of adding the gases to the molten charge creates turbulence in this area. The extreme conditions encountered by the refractory lining in the area of the tuyere pipes causes the refractories and the pipe lining to wear back at a rate exceeding the wear in other parts of the vessel. The environment in copper converters is especially harsh for refractories.

When the tuyere area is worn to a thickness considered unsafe for further use, it is common to cool down the vessel, remove the worn area and replace it. Such large furnaces with refractory linings usually from 12″ to 24″ thick take several days to cool down to ambient temperatures. Replacing the bricks is a time intensive process and during this the temperature of the converter drops from around 1230° C. to around 50° C. In addition, after the repair is made the vessel must be reheated over two or three days to prevent damage to the refractory lining by too rapid heating. The rest of the lining which is still acceptable for use is damaged by the thermal shock of cooling it down and reheating it, thus shortening its life. Additionally, disposal of the worn bricks may create environmental issues as the bricks typically contain chromium.

### BRIEF SUMMARY

The present invention relates to a method of repairing the refractory lining of a converter. In one aspect, a method of repairing the lining of a converter is provided. In one aspect, the method includes disposing a refractory composition onto a worn surface of the converter, wherein the refractory composition includes alumina, silicon carbide, and silica. In one aspect, the refractory composition includes about 55% to about 90% alumina, about 2.5% to about 30% silicon carbide, and about 2% to about 20% silica. In another aspect, the method includes disposing a nozzle into a tuyere, pumping a refractory composition through the nozzle and onto a worn surface of the converter, and allowing the refractory composition to flow onto the worn surface of the refractory.

In another aspect, a lining disposed on a worn surface of a converter is provided. The lining includes a refractory composition including alumina, silicon carbide, and silica. In one aspect, the refractory composition includes about 55% to about 90% alumina, about 2.5% to about 30% silicon carbide, and about 2% to about 20% silica.

The present invention will best be understood with reference to the detailed description below in connection with the attached drawings.

### BRIEF DESCRIPTION OF THE DRAWINGS

FIG. 1 is a cross-sectional side view of a converter showing a method of repairing the lining.

### DETAILED DESCRIPTION OF THE EMBODIMENTS OF THE INVENTION

The invention is described with reference to the drawings. The relationship and functioning of the various elements of this invention are better understood by the following detailed description. However, the embodiments of this invention as described below are by way of example only, and the invention is not limited to the embodiments illustrated in the drawings.

As used herein the term “converter” is meant to include any type of vessel used to smelt or refine metal which has tuyeres for injecting gases into the molten metal. In particular, the term converter includes Pierce Smith, El Teniente, and Refining Converters. For example, the Pierce-Smith converter has been widely used to convert non-ferrous metal mattes to the metal or metal sulphide. Fundamentally, the Pierce-Smith converter is made up of a horizontal cylinder providing within it an elongated sealed refractory lined chamber having a cylindrical sidewall and circular endwalls. The sidewall is provided with a hooded opening for charging and discharging located between the endwalls and a row of tuyeres entering the chamber through the refractory lining at one side. The vessel is rotated between a charging position in which the opening is accessible from the side that it can be charged and a blowing position in which the charging opening faces upward and is hooded and forms an off-gas outlet.

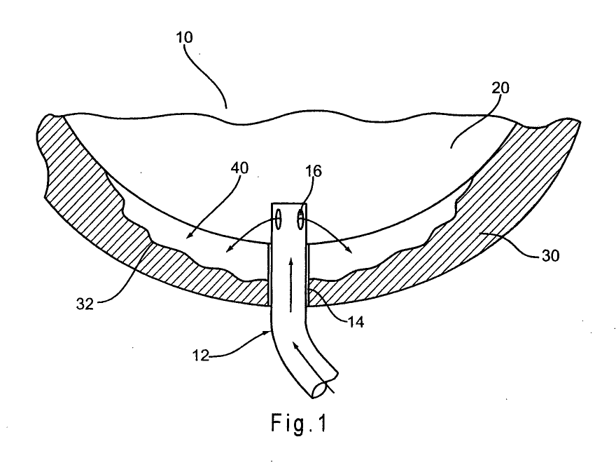

FIG. 1 shows a side cross sectional view of a section of a converter 10. The converter 10 has an exterior wall 30 and an open interior 20. Tuyeres 14 are used during operation of the converter to supply air into the converter 10. The exterior wall 30 is generally made from bricks. The existing bricks may be made from a variety of materials, but generally include magnesite (MgO), chrome (Cr₂O₃), and/or zirconia (ZrO₂). A worn area 32 is shown where the conditions inside the converter have worn down the surface of the bricks in wall 30 to an undesirable thickness.

In one embodiment, the method of repairing the converter includes inserting a nozzle assembly 12 through the tuyere line 14. The nozzle assembly includes nozzle openings 16. In one embodiment, nozzle openings 16 are disposed on the side portion of nozzle assembly 12 to facilitate the dispersion of the refractory composition. Other nozzle designs are possible, including nozzle openings at other positions along the side portion of the nozzle assembly or through the top of the nozzle assembly. A refractory composition is pumped through the nozzle assembly into the interior of the converter. The nozzle openings 16 allow the material to flow sideways out of the nozzle assembly and into the worn area. The flow properties of the refractory composition are such that it spreads easily and fills the worn area up to the desired thickness of the lining, as shown by 14. In one embodiment, the converter is rotated so that the tuyere is positioned at the 6 o'clock position to allow for best flowability of the refractory composition. The setting time of the refractory composition depends on temperature and may depend on other environmental conditions such as humidity and air circulation. In one embodiment, the refractory composition sets sufficiently enough to adhere to the converter wall in about 20 to about 30 minutes, and completely sets in about one to about three hours. The set time can be adjusted by varying the amount of a setting agent.

The repair process may be used when the converter is still at an elevated temperature. In one embodiment, the temperature of the converter at the start of the repair process is greater than about 700° C. In another embodiment, the temperature of the converter at the start of the repair process is greater than about 800° C. In yet another embodiment, the temperature of the converter at the start of the repair process is greater than about 850° C. In this context, the temperature of the converter means the temperature of the lining of the converter in the area to be repaired.

In one embodiment, the refractory composition comprises alumina (Al₂O₃), silicon carbide (SiC), and silica (SiO₂). In one embodiment, the refractory composition includes about 55% to about 90% Al₂O₃ by solids weight. In another embodiment, the refractory composition includes about 70% to about 80% Al₂O₃ by solids weight. In another embodiment, the refractory composition includes about 73% Al₂O₃ by solids weight.

In one embodiment, the alumina is selected from at least one of brown fused alumina, white fused alumina, tabular alumina, reactive alumina, calcined alumina, and aluminosilicate such as mullite or bauxite type material. In another embodiment, the alumina has an average particle diameter in the range of about 30 micrometers through about 7 millimeters.

In one embodiment, the refractory composition includes about 2% to about 30% SiC by solids weight. In another embodiment, the refractory composition includes at least about 2% SiC by solids weight. In another embodiment, the refractory composition includes up to about 30% SiC by solids weight. In another embodiment, the refractory composition includes up to about 20% SiC by solids weight. In another embodiment, the refractory composition includes about 10% to about 20% SiC by solids weight. In another embodiment, the refractory composition includes about 17% SiC by solids weight.

In one embodiment, the silicon carbide has an average particle diameter in the range of about 30 micrometers through about 3.5 millimeters, in order to promote flow of the composition during pumping and strength of the resulting product.

In one embodiment, the refractory composition includes at least about 2% SiO₂ by solids weight. In another embodiment, the refractory composition includes about 2% to about 20% SiO₂ by solids weight. In another embodiment, the refractory composition includes about 5% to about 10% SiO₂ by solids weight. In another embodiment, the refractory composition includes about 6.5% SiO₂ by solids weight.

In one embodiment, the silica is provided in the form of an aqueous colloidal silica binder. The silica may be provided by an alumino-silicate type material or a fumed silica material in addition to the aqueous colloidal silica binder. In one embodiment, alumino-silicate material provides up to about 15% of the silica. In another embodiment, fumed silica material provides up to 10% of the silica. The colloidal silica imparts excellent flow properties that permit the refractory composition to be easily transported from a source to a destination using a pump or another suitable means. After the refractory sets, the colloidal silica acts as a binder, thus contributing strength and erosion resistance to the refractory.

The aqueous colloidal silica binder comprises colloidal silica in water, where the colloidal silica may be in the range of about 15% through about 70% by weight of the aqueous colloidal silica binder. In one embodiment, the colloidal silica is in the range of about 30% through about 50% by weight of the aqueous colloidal silica binder. In another embodiment, the colloidal silica is about 40% by weight of the aqueous colloidal silica binder. The colloidal silica may have an average particle diameter in the range of about 4 millimicrons through about 100 millimicrons. In one embodiment, the colloidal silica has an average particle diameter in the range of about 6 millimicrons through about 50 millimicrons. In another embodiment, the colloidal silica has an average particle diameter in the range of about 8 millimicrons through about 20 millimicrons.

In one embodiment, the refractory composition includes up to about 5% titania (TiO₂). In another embodiment, the refractory composition includes about 0.1% to about 5% titania.

In one embodiment, the refractory composition includes up to about 1% lime (CaO). In another embodiment, the refractory composition includes about 0.1% to about 5% lime.

In one embodiment, the refractory composition includes up to about 10% by solids weight free carbon. In one embodiment, the free carbon has an average particle diameter of about 40 microns to about 0.5 mm. In one embodiment, the refractory composition includes about 1% to about 5% by solids weight free carbon, and in another embodiment, the refractory composition includes less than about 2% by solids weight free carbon. In another embodiment, the refractory composition includes less than about 1% by solids weight free carbon. In one embodiment, the carbon is in the form of petroleum pitch, which is a mixture of carbon and volatile organic compounds. In another embodiment, the carbon is in the form of graphite.

The refractory composition may have other components, especially those associated with the manufacture of refractory compositions.

In one embodiment, the composition of the refractory material is shown in the following table:

TABLE 1

| Component | Amount |
|---|---|
| alumina | 73% |
| silicon carbide | 17.5% |
| silica | 6.5% |
| calcium oxide | 1% |
| iron oxide | 1% |
| titanium dioxide | 1% |

Although not intending to be bound by any particular theory, the alumina is believed to provide high temperature strength. The silicon carbide is believed to provide resistance to slag and molten metal. Titania improves the resistance of the refractory to the off-gases. The titania may be added or may be introduced as a minor component of raw materials used to manufacture the refractory. In one embodiment, the titania is present in brown fused alumina or bauxite. The titania may be less than about 5% of the brown fused alumina or bauxite. The alumina improves strength of the refractory material without significantly increasing the susceptibility to attack from slag. If titania is used, the titania may have the same average particle diameter as the alumina.

### EXAMPLE

A colloidal silica composition having the composition shown in Table 1 was used to make repairs in a copper converter according to the method of the present invention. The composition dried successfully and showed good adhesion to the existing refractory surface.

The embodiments described above and shown herein are illustrative and not restrictive. In certain cases, materials of construction have not been described; in these cases, it is to be understood that the invention may be made by any known method and of any known material. The scope of the invention is indicated by the claims rather than by the foregoing description and attached drawings. The invention may be embodied in other specific forms without departing from the spirit of the invention. Accordingly, these and any other changes which come within the scope of the claims are intended to be embraced therein.

1. A method of repairing the lining of a converter comprising:
disposing a refractory composition onto a worn surface of the converter, wherein the refractory composition comprises alumina, silicon carbide, and silica.

2. The method of claim 1 wherein the refractory composition comprises about 55% to about 90% alumina, about 2.5% to about 30% silicon carbide, and about 2% to about 20% silica.

3. The method of claim 1 wherein disposing a refractory composition onto a worn surface of the converter comprises disposing a nozzle into a tuyere and pumping a refractory composition through the nozzle and onto a worn surface of the converter.

4. The method of claim 1 wherein disposing a refractory composition onto a worn surface of the converter comprises shotcreting the refractory composition onto a worn surface of the converter.

5. A method of repairing the lining of a converter comprising:
disposing a nozzle into a tuyere;
pumping a refractory composition through the nozzle and onto a worn surface of the converter; and
allowing the refractory composition to flow onto the worn surface of the converter,
wherein the refractory composition comprises alumina, silicon carbide, and silica.

6. The method of claim 5 wherein the refractory composition comprises colloidal silica.

7. The method of claim 5 wherein the refractory composition comprises about 55% to about 90% alumina, about 2.5% to about 30% silicon carbide, and about 2% to about 20% silica.

8. The method of claim 5 wherein the refractory composition comprises about 70% to about 80% alumina, about 15% to about 20% silicon carbide, and about 5% to about 10% silica.

9. The method of claim 5 wherein the refractory composition comprises up to about 2% TiO₂.

10. The method of claim 5 wherein the temperature of the converter is greater than 700° C.

11. The method of claim 5 wherein the temperature of the converter is greater than 800° C.

12. The method of claim 5 wherein the temperature of the converter is greater than 850° C.

13. A lining disposed on a worn surface of a converter, the lining comprising a refractory composition comprising alumina, silicon carbide, and silica.

14. The lining of claim 13 wherein the refractory composition comprises about 55% to about 90% alumina, about 2.5% to about 30% silicon carbide, and about 2% to about 20% silica.

15. The lining of claim 13 wherein the refractory composition comprises about 70% to about 80% alumina, about 15% to about 20% silicon carbide, and about 5% to about 10% silica.

16. The lining of claim 13 wherein the refractory composition comprises up to about 2% TiO₂.
